(19) United States
(12) Patent Application Publication
(10) Pub. No.: US 2008/0056139 A1
(43) Pub. Date: Mar. 6, 2008

(54) Network traffic monitoring using embedded target-side analyzer during embedded software development

(75) Inventor: Touseef Liaqat, Lahore (PK)

Correspondence Address: Trellis Intellectual Property Law Group, PC, 1900 EMBARCADERO ROAD, SUITE 109, PALO ALTO, CA, 94303, US

(73) Assignee: Mentor Graphics Corporation, Wilsonville, OR (US)

(21) Appl. No.: 11/517,545

(22) Filed: Sep. 6, 2006

(51) Int. Cl. H04J 3/14

(52) U.S. Cl. 370/242; 370/392

(57) ABSTRACT

A debugging system running on a host device uses an embedded target-side network analyzer to acquire communications information such as packets. The target-side network analyzer logs and analyzes packets by obtaining data from the target's Internet Protocol (IP) stack when diagnostic functions are invoked at breakpoints. This allows display, logging, analysis and other uses of decoded network traffic. This approach can be used in applications (e.g., wireless or those using protocols such as RADIUS and PPP, etc.) where identifying and intercepting traffic to or from a specific target device may be difficult or impossible. With this approach developers can analyze network traffic in real time without any special hardware.

### BACKGROUND OF THE INVENTION

This invention relates in general to digital network embedded system debugging and testing and more specifically to monitoring and analyzing data transferred over a digital network embedded system during a development process, to debug and test the network protocol being developed.

As digital communication systems become more prevalent and complex it is increasingly important to have efficient and effective tools to analyze the operation of these systems. One approach to analysis uses a data collector that is inserted or attached a digital network. The data collector is often referred to as a “packet sniffer.” Insertion of the sniffer can be by placement of monitoring hardware or software into a communication channel through which traffic to be monitored is known to flow. However, one problem with this approach is that certain types of communication systems, such as those using wireless protocols (e.g., IEEE 802.1X, etc.) or other protocols such as Remote Authentication Dial-In User Service (RADIUS), Point-to-Point Protocol (PPP), etc., do not allow the sniffer to be reliably included within a channel that can intercept all desired communications.

One solution has been to create an intermediary node in the network that will intercept traffic to desired target systems. But this type of deployment increases the cost and time of development, debugging or analysis as extra hardware and modification of the network topology are required.

In applications where encryption or specific encoding is used on the transferred data it is not always feasible, or possible, to place the packet sniffer at a point where unencrypted data can be obtained. Thus, it may be difficult or impossible to provide a human analyst with intelligible results from the packet sniffing.

In prior art approaches, the packet sniffer is usually implemented largely in software on a host system that is connected to the target to be analyzed. In this case a problem occurs when it is inconvenient to connect a host system to the target to be monitored.

### SUMMARY OF EMBODIMENTS OF THE INVENTION

A debugging system running on a host device uses an embedded target-side network analyzer to acquire communications information such as packets. The target-side network analyzer logs and analyzes packets by obtaining data from the target's network software stack when diagnostic functions are invoked at breakpoints. This allows display, logging, analysis and other uses of decoded network traffic. This approach will be most helpful in applications (e.g., wireless or those using protocols such as RADIUS and PPP, etc.) where identifying and intercepting traffic to or from a specific target device may be difficult or impossible. With this approach developers can analyze network traffic in real time without any special hardware.

One embodiment of the invention provides A method for analyzing communications data at a target device, wherein the target device includes an embedded system, the method comprising the following performed by a processor in a host device: receiving a signal from a user input device to define a script function to access data in a buffer associated with a protocol stack in the embedded system; running an analysis tool on the host device to execute the script function; and transferring at least a portion of the accessed data for analysis.

### BRIEF DESCRIPTION OF THE DRAWINGS

FIG. 1 illustrates monitoring of data packets in a communication system according to an embodiment of the invention;

FIG. 2 shows details of the host and target systems of FIG. 1;

FIG. 3 shows details of a packet acquisition mechanism;

FIG. 4 illustrates setting of a script function invocation to read a send buffer;

FIG. 5 illustrates setting of a script function invocation to read a receive buffer;

FIG. 6 shows a graphical user interface mode of display of packet information; and

FIG. 7 shows a log file mode of storing packet information.

### DETAILED DESCRIPTION OF EMBODIMENTS OF THE INVENTION

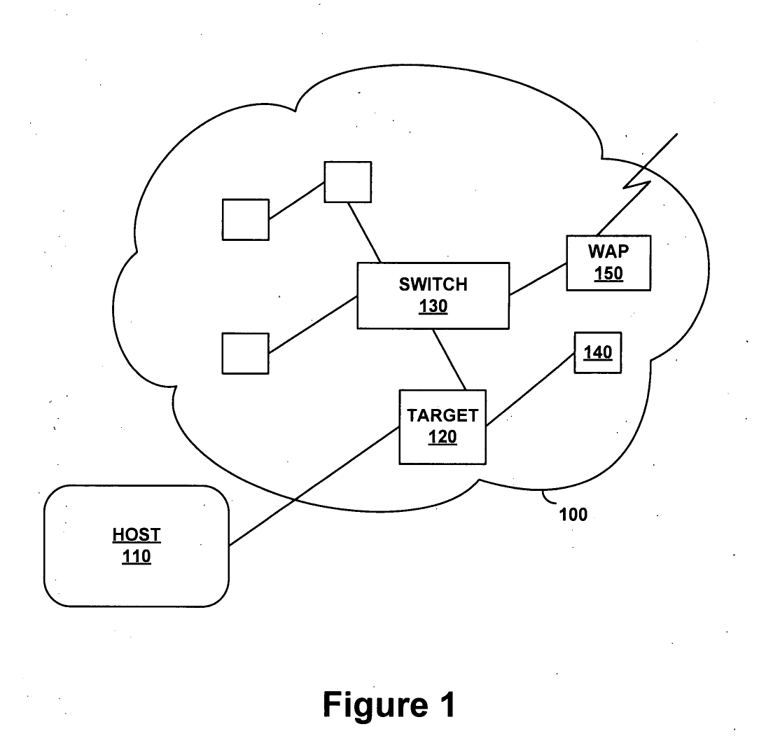

FIG. 1 illustrates monitoring of data packets in a communication system according to an embodiment of the invention.

In FIG. 1, digital network 100 includes several nodes such as 120 and 140. Node 120 is coupled to other nodes via a routing device such as switch 130. Additional types of devices can be included such as wireless access point 150. In general, any number and type of devices can be connected in any topology. Different types of communication links (e.g., wired, wireless, optical, etc.) can be used as is known in the art.

Host 110 is, e.g., general-purpose computer that communicates with the target node 120 via a serial port or other network connection. Host 110 executes a debugger that can include tools and functions to test and debug software in an embedded system in the target. Some common debugger functions allow a developer of an embedded system (i.e., a “user”) to download software to the target for execution or debugging. Breakpoints can be set to examine the contents of specific memory locations and registers.

a computer system that executes monitoring and analysis software. Host 110 is connected to node 120 for purposes of analyzing the network traffic that flows through node 120. Node 120 includes an embedded system that can be a combination of processing hardware and software, and perhaps additional mechanical or other parts, designed to perform a specific function.

Node 120 is referred to as the target device since it is the device of interest. Typically, node 120 is the only device with which host 110 can communicate directly since, e.g., the test setup is for software on host 110 to assist in debugging the system at node 120. Even though host 110 is not in direct communication with switch 130 or node 140, host 110 can still obtain information about traffic flowing between switch 130 and node 140 by using mechanisms that access the protocol stack of node 120. Also, as discussed in more detail below, host 1 10 can be provided with decoded and formatted packet information.

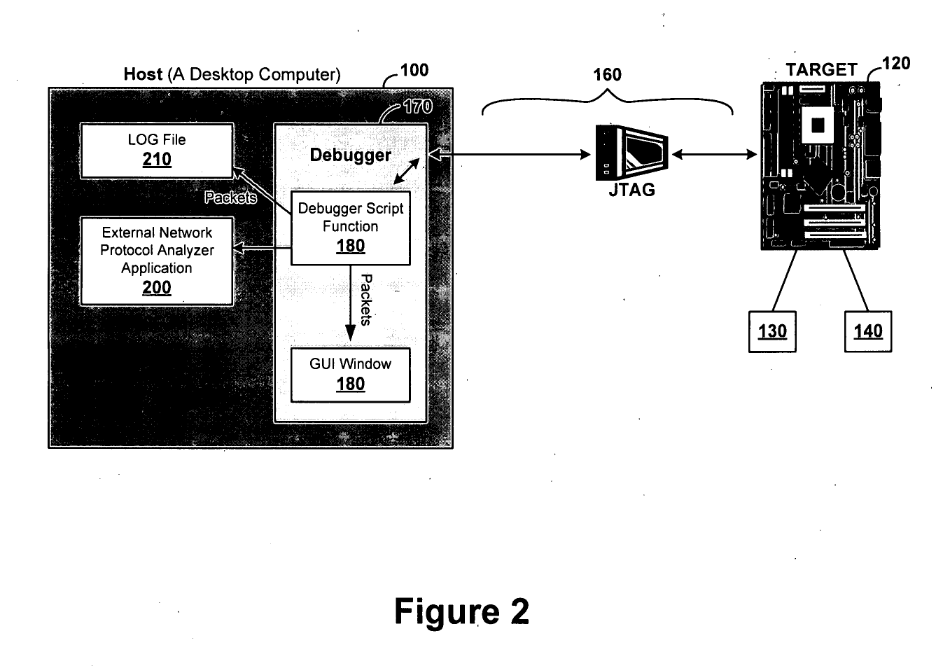

FIG. 2 shows host 110 and node or target 120 of FIG. 1. In general, items with the same reference numbers in different Figures are used to indicate the same item unless otherwise noted. As described above, target 120 is connected to other devices such as switch 130 and node 140 via a digital network. A preferred embodiment of the invention uses a debugging system as the mechanism to monitor and obtain packet information from the IP stack of the target. The debugging system includes packet acquisition mechanisms for examining an IP stack of an embedded system in the target device. In general, the target can be any device which has debugging support and can connect to a host in a software development process for debugging purposes. Other embodiments may include target devices for other than test purposes.

A preferred embodiment of the invention uses a debugging system manufactured and distributed by Mentor Graphics, Inc. of Wilsonville, Oreg., referred to as “Nucleus EDGE™.” The debugging system runs on a host computer under Windows™ XP operating system. In other embodiments any other suitable debugger, hardware, operating system or environment (i.e., platform) can be used (e.g., Linux, etc). This debugging approach includes many of the same features as standard debugging systems, but also provides for advanced debugging functionality on the target device by allowing programmer/analysts to write functions in a script for interfacing with the target. The script functions, often also referred to as “codelets,” run in the context of the debugger but also have extensive access to and control over the target embedded system. Note that any other suitable debugging or analysis system may be adaptable for use with embodiments of the invention.

Codelet script functions are written in standard C language syntax. However, any suitable programming language, format, syntax, protocol or approach can be adapted for script function implementations. The script functions are allowed low-level access to hardware such as to read and write registers, target memory and variables. The script functions can call target functions, make system calls on the host, spawn applications on the host, access and modify debugger channels including accessing and modifying files on the host, sockets to other computers, serial ports on the host, set up proxy channels bound to viewers in a graphical user interface (GUI), call library routines, etc. Other embodiments can allow varying levels of script function access to host and target resources, as desired.

Host 110 is connected to target 120 by debug connection 160. This can be any suitable communication link such as those adhering to standards promoted by Joint Test Action Group (JTAG). Packet information obtained from the target's IP stack is transferred over the JTAG interface to debugger process 170 executing within host 1 10 as an application program. Debugger process 170 includes debugger script function 180 that receives the packet information and provides it to GUI process 190 for display on a display screen. Packet information can also be provided to external programs such as external analyzer application 200, and to log file 210. Packet information can be provided to external analyzers or other programs in, for example, Ethereal or other format by Inter-Process Communication means such as by local sockets, pipes, files, etc. Log file 210 can be stored in a Propagation Code Analysis Program (PCAP) format for later transfer or analysis. Other uses of the packet information are possible.

Although host 110 is shown as a single system, other configurations for processing at the host side are possible. Any one or more processing devices can be used to implement the functionality corresponding to the items shown within host 110 in FIG. 2. Different types and organizations of processes can be used. The specific components and steps described herein are merely to show one example of basic functionality.

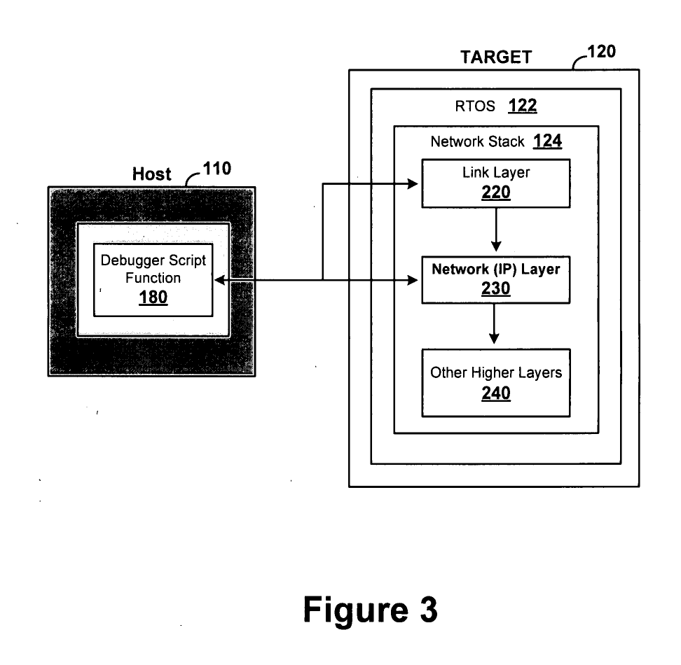

FIG. 3 shows details of a packet acquisition mechanism.

In FIG. 3, target 120 includes a Real Time Operating System (RTOS) 122 that processes the network stack. The RTOS is adapted for use by a JTAG interface including instructions capable of interrupting RTOS execution and examining or modifying values within the stack. Aspects of the stack include information at different layers such as link layer 220, network IP layer 230, or other layers 240. Note that it is possible that packet or other communication information may be obtained by other mechanisms and at other places within the target.

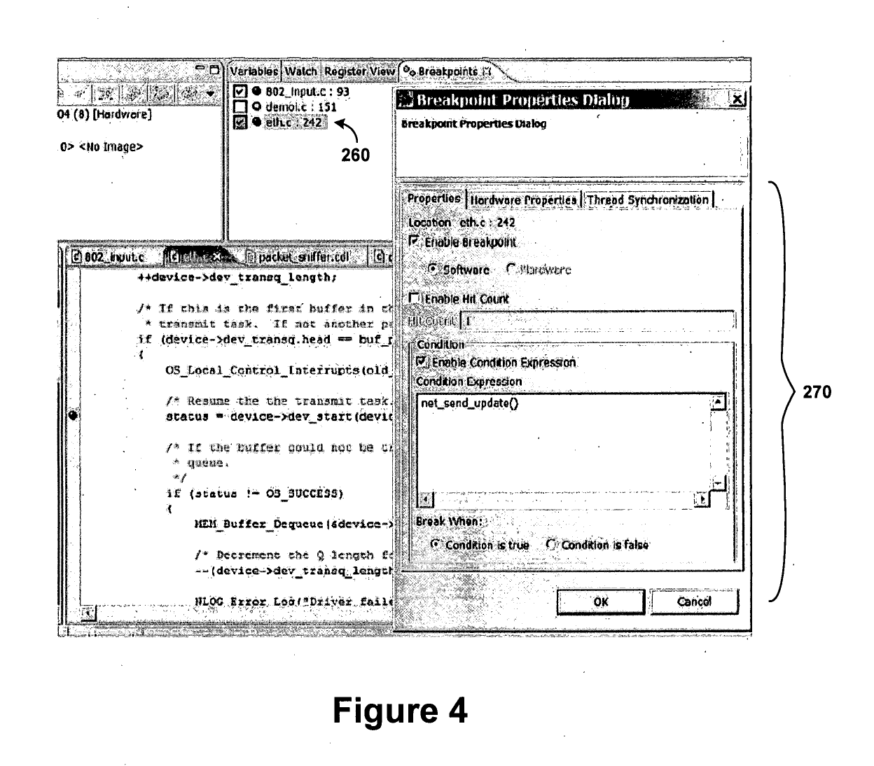

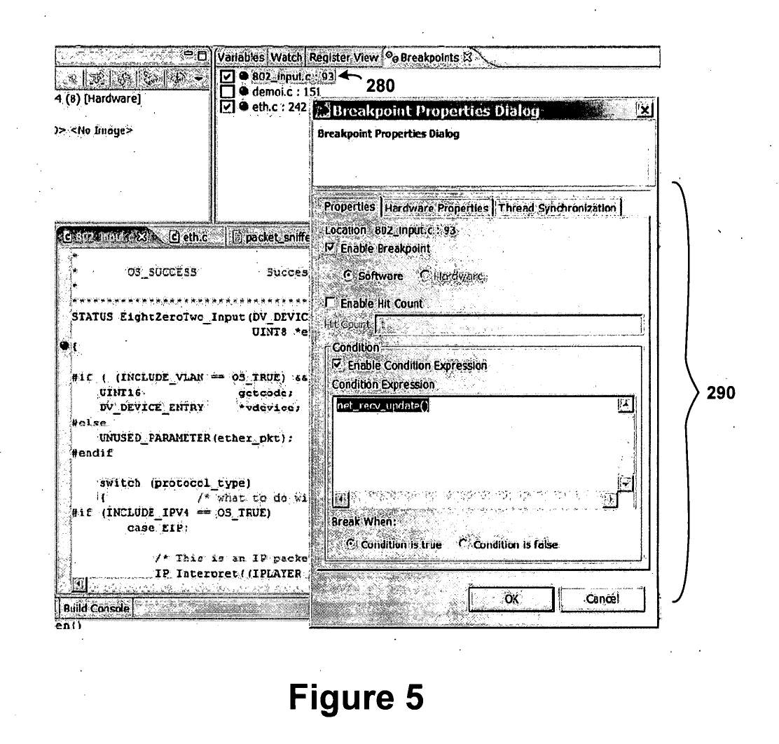

FIGS. 4 and 5 show how acquisition of packet information is triggered by a breakpoint in debugger script function.

In FIG. 4, the send function, net_send_update( ), is inserted at line 242 of eth.c as shown in the interface image at 260 and 270. This send function is called when the breakpoint is encountered during execution of the debugging code. When called, the send function reads a packet buffer containing information that is about to be sent to the network by the target. The packet buffer information is then output according to a selected mode. It should be apparent that the functions described herein are examples, and that any other functions, procedures, routines, etc., with different names and purposes can be used.

Similarly, for received packets, the receive function, net_recv_update( ), is called when a breakpoint at file 802_input.c is encountered. This breakpoint is shown being set in the interface of FIG. 5 at 280 and 290. The receive function reads the packet buffer that has just been received from the network interface by the target. The received packet buffer information is output according to a selected mode.

A preferred embodiment of the invention allows three basic modes of output: (1) graphical user interface (GUI) mode; (2) file mode and (3) external analyzer mode.

When GUI mode is enabled the packets sent and received by the target on the network are displayed in a debugger input/output (I/O) window. The packets are parsed and useful fields and their values are interpreted and displayed. Fields can be any definable field in the communications data. For example, for packets some common field include source IP address, destination IP address, source Medium Access Control (MAC) address, destination MAC address, protocol name, etc. Any one or more of the field values can be displayed along with the field name to assist a human user or developer/analyst in understanding the captured packet data.

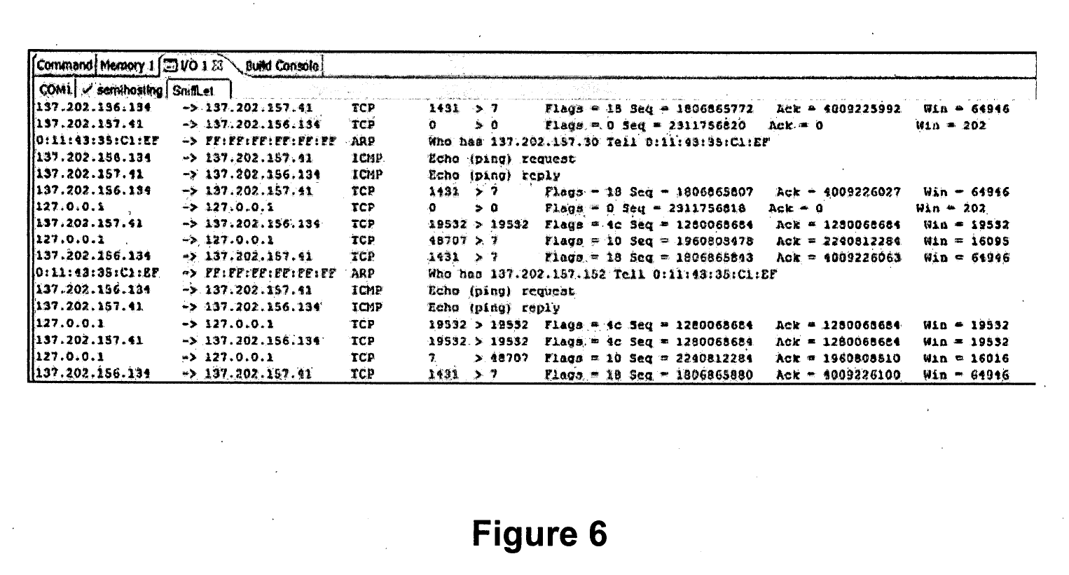

FIG. 6 shows a screen display of packet information in the GUI mode. The packet information has been interpreted by the debugging system so that informational field names and values are displayed in an organized and intelligible manner. The protocol type can typically be determined by the script function by analyzing the packet buffer received from the target device (e.g., from the protocol stack). Additional information that is dependent on the packet protocol type can thus be provided, such as additional unique fields and values that are used by specific protocols. Protocol-specific information can be displayed with well-known protocols such as TCP, UDP and ICMP, MAC, TCP/IP, etc. If protocol-specific information is not available then a packet dump can be displayed. Users can define and add protocol dependant information for new protocols, if not already available. Future embodiments are planned to support IPSec, 802.1X and IETF Virtual Private Network (VPN) protocols. Additional GUI features and controls can be provided in order to extend the interpretation ability of the system.

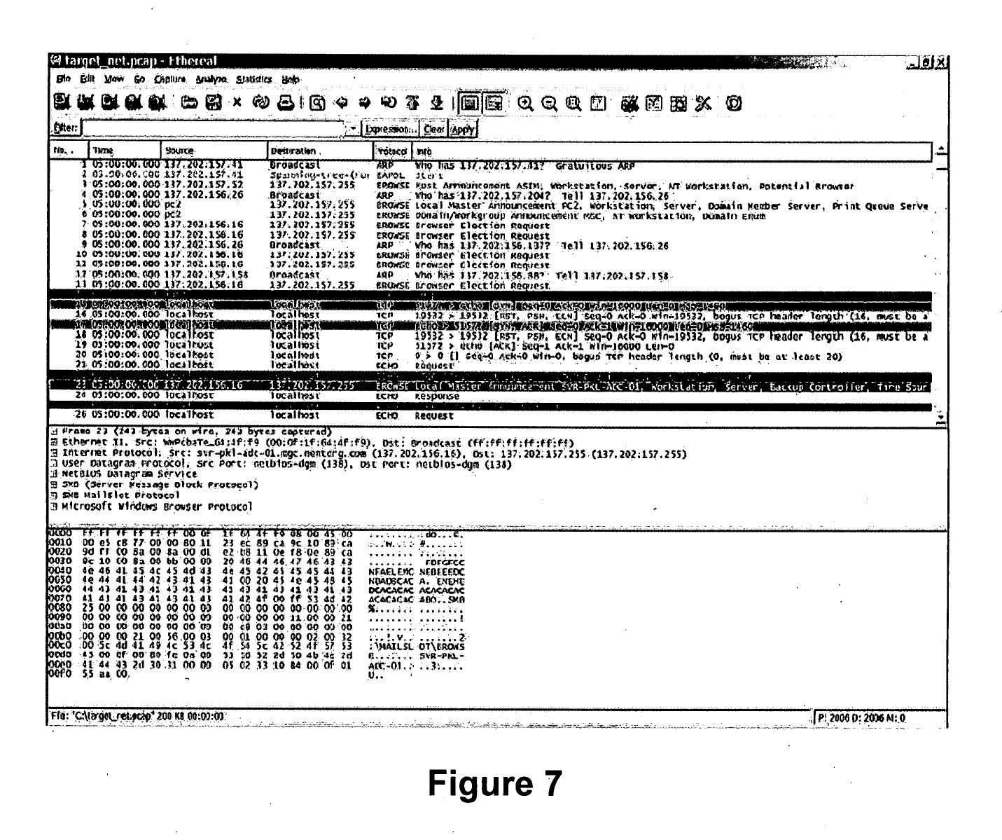

FIG. 7 shows information in the FILE mode displayed in an external analyzer. When FILE mode is enabled, packets received and sent by the target are stored in a log file. The file is written in the popular PCAP format which allows the packet data to be further analyzed by external packet sniffers and analyzers. The log file can be opened in a packet sniffer such as Ethereal and subsequent detailed analysis can be carried out.

Another mode allows packet information to be sent directly (without being first stored in a log file) to an external third party packet analyzer. The means for transferring the packet information can include any suitable communication channel such as sockets, pipes or any suitable Inter-Process Communication (IPC) method.

Benefits provided by the approaches described herein can include target side packet sniffing, reduction in the cost of network protocol development, faster and more integrated real time debugging, easier extensibility, easier adaptation for inclusion in middleware software products, ability to monitor traffic to targets without insertion into topology, accessibility to decoded data, and other benefits.

Since this method works on the target side it is not as susceptible to packet loss and delays introduced by communication methods such as Ethernet wires, switches/hubs, routers etc. A user can change the output format of the packets and add protocol dependant information in the output. Data display can be refined using filters applied by modifying user script functions.

Script functions can be designed to obtain the decrypted output of encrypted protocols because the script functions typically have access to necessary software routines of the target application including the routines to decrypt it. This makes analysis easier while working with security protocols. With this approach debugging IETF IPSec/IKE like protocols is possible.

The script functions and IP stack data acquisition can be independent of the MAC layer so the acquisition can work with any physical medium running a TCP/IP stack. For example, TCP/IP over Ethernet, WLAN, USB, WiMAX support is possible. The functionality described herein can be provided as a standalone system, or as a plug-in, enhancement, extension, library, Application Program Interface (API) or in any other format.

Although embodiments of the invention have been discussed primarily with respect to specific arrangements, formats, protocols, etc. any other suitable design or approach can be used. Specific details may be modified from those presented herein without deviating from the scope of the claims. The embodiments described herein are merely illustrative, and not restrictive, of the invention. For example, although embodiments of the invention are described with reference to a “packet sniffer” and debugger any similar functionality as is typically found in a network analyzer, Ethernet sniffer, data collector or other analysis tool may be similarly used with features of the invention. Not all of the functionality presented here need be used in every embodiment of the invention. For example, an analysis tool might provide different degrees or levels of decoding packet information and formatting the packet content for display. Third party products can be used to implement parts of the functionality, as desired.

Breakpoints and the functions that breakpoints invoke, along with other characteristics of breakpoints as described herein, can be stored for later use. The stored breakpoints can be loaded so that they automatically become part of the debugging resources (e.g., added as breakpoints to places in the embedded system code). Pre-defined breakpoints can be created by a user for the user's particular use, or they can be created by third-party designers and manufacturers as part of a suite of tools for debugging.

One way of implementing automated breakpoint loading and setting is to perform loading in a codelet script initialization module. The initialization module can be called when a particular codelet is loaded in the debugger. The initialization module calls the debugger commands to install the predefined breakpoints.

Any suitable programming language can be used to with the present invention including C, C++, Java, PL/I, assembly language, etc. Different programming techniques can be employed such as procedural or object oriented. The routines can execute on a single processing device or multiple processors. Although the flowchart format demands that the steps be presented in a specific order, this order may be changed. Multiple steps can be performed at the same time. The flowchart sequence can be interrupted. The routines can operate in an operating system environment or as stand-alone routines occupying all, or a substantial part, of the system processing. Details of languages and techniques may be found, for example, in references such as Programming Embedded Systems in C and C++ by Michael Barr, January 1999, O'Reilly.

Steps can be performed by hardware or software, as desired. Note that steps can be added to, taken from or modified from the steps in the flowcharts presented in this specification without deviating from the scope of the invention. In general, the flowcharts are only used to indicate one possible sequence of basic operations to achieve a function.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein the various databases, application software or network tools may reside in one or more server computers and more particularly, in the memory of such server computers. As used herein, “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for analyzing communications data at a target device, wherein the target device includes an embedded system, the method comprising the following performed by a processor in a host device:
receiving a signal from a user input device to invoke a script function to access data in a buffer associated with a network protocol stack in the embedded system;
running an analysis tool on the host device to execute the script function; and
transferring at least a portion of the accessed data for analysis.

2. The method of claim 1, wherein the protocol stack includes an Internet Protocol (IP) protocol.

3. The method of claim 1, wherein the protocol stack includes a Medium Access Control (MAC) protocol.

4. The method of claim 1, wherein the embedded system includes a Real-Time Operating System (RTOS).

5. The method of claim 1, wherein the protocol stack includes a Transmission Control Protocol/Internet Protocol (TCP/IP) protocol.

6. The method of claim 1, wherein the script function reads data from a send buffer.

7. The method of claim 1, wherein the script function reads data from a receive buffer.

8. The method of claim 1, wherein the script function is executed from within a debugger running on the host device.

9. The method of claim 8, further comprising:
receiving a signal from a user input device to define a breakpoint in the debugger; and
executing the script function when the breakpoint is reached.

10. The method of claim 9, wherein the breakpoints are predefined and stored in a file, the method further comprising:
loading the file of predefined breakpoints.

11. The method of claim 9, wherein the script function includes a codelet.

12. The method of claim 1, wherein the step of transferring at least a portion of the accessed data includes:
parsing a packet to obtain values, wherein each value corresponds to a field; and
displaying the values along with the corresponding fields.

13. The method of claim 12, wherein a field includes a source IP address.

14. The method of claim 12, wherein a field includes a destination IP address.

15. The method of claim 12, wherein a field includes a source MAC address.

16. The method of claim 12, wherein a field includes a destination MAC address.

17. The method of claim 12, wherein a field includes a protocol name.

18. The method of claim 12, wherein the IP stack uses a specific protocol, the method further comprising:
determining the specific protocol; and
displaying information relevant to a field in the specific protocol.

19. The method of claim 1, wherein the step of transferring at least a portion of the accessed data includes:
transferring the at least a portion of the accessed data to a log file.

20. The method of claim 19, wherein the transferred data is in the Propagation Code Analysis Program (PCAP) format.

21. The method of claim 1, wherein the step of transferring at least a portion of the accessed data includes:
transferring the at least a portion of the accessed data to an external application.

22. The method of claim 21, wherein the external application includes an analyzer.

23. An apparatus for analyzing communications data at a target device, wherein the target device includes an embedded system, the apparatus comprising:
A processor;
A machine-readable storage medium including instructions executable by the processor for:
receiving a signal from a user input device to invoke a script function to access data in a buffer associated with a network protocol stack in the embedded system;
running an analysis tool on the host device to execute the script function; and
transferring at least a portion of the accessed data for analysis.

24. A machine-readable storage medium including instructions executable by a processor, the machine-readable storage medium including one or more instructions for:
receiving a signal from a user input device to invoke a script function to access data in a buffer associated with a network protocol stack in the embedded system;
running an analysis tool on the host device to execute the script function; and
transferring at least a portion of the accessed data for analysis.
